(19) United States
(12) Patent Application Publication
(10) Pub. No.: US 2007/0025369 A1
(43) Pub. Date: Feb. 1, 2007

(54) Method for transmitting data in a data network

(76) Inventors: Andreas Hutter, Munchen (DE); Jurgen Pandel, Feldkirchen-Westerham (DE); Joachim Sokol, Unterhaching (DE); Marcel Wagner, Munchen (DE)

Correspondence Address: STAAS & HALSEY LLP, SUITE 700, 1201 NEW YORK AVENUE, N.W., WASHINGTON, DC, 20005, US

(21) Appl. No.: 10/569,689

(22) PCT Filed: Aug. 4, 2005
(86) PCT No.: PCT/EP04/51705

§ 371 Date: Feb. 27, 2006

(30) Foreign Application Priority Data
Aug. 27, 2003 (DE) 10339497.4

(51) Int. Cl. H04L 12/56; H04J 3/16

(52) U.S. Cl. 370/401; 370/469

(57) ABSTRACT

Data are transmitted in a data network modelled by layers that include a transport layer, a plurality of upper layers above the transport layer and a plurality of lower layers below the transport layer, where the transport layer contains data from the upper layers.

### CROSS REFERENCE TO RELATED APPLICATIONS

This application is based on and hereby claims priority to German Application No. 10339497.4 filed on Aug. 27, 2003, the contents of which are hereby incorporated by reference.

### BACKGROUND OF THE INVENTION

1. Field of the Invention

The invention relates to a method for transmitting data in a data network and a corresponding device for processing data and a corresponding network.

2. Description of the Related Art

When transmitting multimedia data in a data network, the problem arises that the data is usually transported via a plurality of networks and therefore unpredictable fluctuations occur in the available bandwidths of the networks. This applies particularly in the case of transmission via wireless networks e.g. UMTS (UMTS=Universal Mobile Telecommunication Service), GPRS (GPRS=General Package Radio Service) and WLAN (WLAN=Wireless Local Area Network). At the critical network transition points, in particular in the case of a transition point from a wire-based network to a wireless network, it is desirable to adapt the data streams in a network node, e.g. a gateway server or a proxy server, in order to avoid overload situations and data packet losses resulting therefrom.

The related art discloses various solutions for adapting multimedia streams to bandwidth fluctuations. In a first solution, the quality of the data stream is monitored by the server which provides the multimedia data, and the data speed is adapted correspondingly in the event of packet losses. The disadvantage of this solution is a long response time, since the server is often very far away from the network points at which the bandwidth fluctuations occur.

As a second solution which is known from the related art, so-called TOS bytes (TOS=Type of Service) or DS bytes (DS=Differentiated Service) are used in the IP layer of the data packets, wherein various priorities of the packets can be flagged using these bytes. A gateway server, for example, is consequently able to recognize and if necessary discard unimportant packets in order to adapt the data speed. The disadvantage of this solution is that the bytes can be modified by all network computers on the path from the server to the client, and it is therefore impossible to guarantee integrity upon receipt at the gateway server.

According to a third alternative, the related art proposes monitoring the so-called RTP connection (RTP=Real Time Protocol) by a so-called Application Layer Gateway. The priority of the data packets can be recognized from the RTP payload of the RTP packets and corresponding measures can be derived therefrom. The disadvantage here is that this procedure is very resource intensive because the whole connection, in particular its setup and its modification, must be monitored in order that the RTP packets can be interpreted.

### SUMMARY OF THE INVENTION

An aspect of the invention therefore is to address the problem of providing a method for transmitting data in a data network, which method simply and efficiently guarantees an adaptation of the data speed in the case of bandwidth fluctuations.

A method according to the invention provides for the data to be transmitted using at least one protocol having a plurality of layers, wherein the layers include a transport layer and a plurality of upper layers above the transport layer and a plurality of lower layers below the transport layer. In this context, the data transmission via layers relates to the OSI reference model (OSI=Open System Interconnection) which is sufficiently well known to a person skilled in the art. A method according to the invention is characterized in that the transport layer contains information from the upper layers. This means that the transport layer, which can easily be read and interpreted by a network computer and particularly by a gateway computer, provides information which originates from higher layers and therefore contains specifications relating to the application being executed and the session that has been established. With the aid of this information, a gateway server can prioritize the individual packets and effectively control the data speed by discarding data in accordance with a predetermined sequence.

In a particularly preferred embodiment of the invention, the information from the upper layers originates from an application layer and/or a session layer. In a further preferred embodiment, the information from the upper layers includes information relating to the application for which the transmitted data is provided. As a result, a gateway server can decide in particular to what extent the discarding of data packets could be problematic for the application.

In a particularly preferred embodiment of the invention, the information from the upper layers contains a priority level for the transmitted data. In this type of configuration, the transmitted data preferably includes encoded data and the priority level specifies how important the data is for correct decoding. The use of the priority level is particularly advantageous when transmitting encoded digitized images, wherein the reciprocal dependencies of the encoded images can be specified using the priority level in such a case. In particular, it is possible to specify here how the individual images depend on each other, i.e. which images preceding an image that must be decoded are required in order to allow a correct decoding.

In a particularly preferred embodiment, the RTP protocol is utilized for the data transmission in the upper layers. This protocol is sufficiently well known from the related art, and is utilized in particular for transmitting multimedia data.

In a further particularly preferred configuration of the invention, the DCCP protocol (DCCP=Datagram Congestion Control Protocol) which is currently being standardized by the IETF is utilized in the transport layer. If this protocol is used, the information from the upper layers is contained in particular in the CCval field of the generic header of the data which is transmitted in the DCCP protocol. Alternatively, however, the information from the upper layers can also be contained in the options field of the special header of the data which is transmitted in the DCCP protocol.

In addition to the above described method for transmitting data, the invention also relates to a device for processing data which is transmitted using the method, wherein the device includes a processor unit by which information from the upper layers can be read and processed, the information being derived from the data that is transmitted in the transport layer. The device is preferably a network computer, in particular a gateway server and/or a proxy server.

The invention also relates to a data network which includes the above mentioned device for processing data. In particular, the data network is a UMTS network and/or an IP network in this context.

### BRIEF DESCRIPTION OF THE DRAWINGS

These and other objects and advantages of the present invention will become more apparent and more readily appreciated from the following description of the exemplary embodiments, taken in conjunction with the accompanying drawings of which:

FIG. 1 is a diagram showing the layered structure of the OSI model;

FIG. 2 is a schematic diagram showing the structure of a data network in which a method according to the invention is utilized;

FIG. 3 is a data diagram showing the structure of a header in the DCCP protocol;

FIG. 4 is a data diagram showing the structure of the generic part of the header from FIG. 3.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

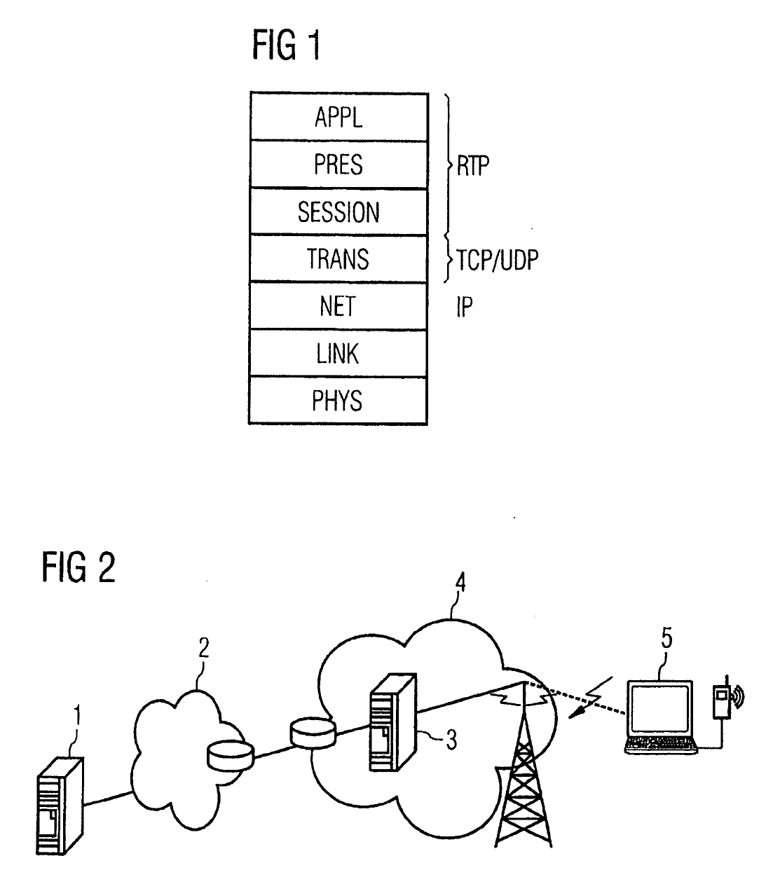

FIG. 1 shows the structure of the layers in the OSI reference model, which is sufficiently well known to a person skilled in the art and is used today for describing the transmission of data in networks.

The lowest layer of the model is the physical layer PHYS, via which the transmission of the data bits takes place. Above this layer is the data link layer LINK, which provides suitable checking and error correction mechanisms for the data streams. Attached to the LINK layer is the network layer NET, where the route is selected via which the data will be carried. The NET layer uses the IP protocol (IP=Internet Protocol), for example. Connected to the NET layer is the transport layer TRANS, which today normally uses the known transport protocols TCP/UDP (TCP=Transport Control Protocol; UDP=User Datagram Protocol). The data is e.g. segmented into packets of suitable size in the TRANS layer. The session layer SESSION is situated above the transport layer and is used for synchronizing the communication in the data network. Attached to the session layer is a presentation layer PRES, and this is finally followed by the highest layer in the form of the application layer APPL, where the actual applications run. The RTP protocol (RTP=Real Time Protocol) is often utilized on the layers above the transport layer and is sufficiently well known to a person skilled in the art.

FIG. 2 shows a data network in which data is transmitted in the form of data packets using a data transmission method according to the invention. The data network includes a server 1, by which data is transmitted via the global Internet 2 to a gateway server 3. This server controls the data transmission from an air interface 4 via a UMTS network to a terminal 5, which can be e.g. a laptop, which is connected to the UMTS network via a mobile telephone.

In the context of data transmission in the network in FIG. 2, the DCCP protocol is used in the transport layer, the DCCP protocol being more suitable than the known UDP transport protocol, in particular for the transport of multimedia data. The main property of the DCCP protocol is that it takes other transport protocols such as e.g. TCP into account and adjusts the data speed downwards in the event of a network overload, for example. So-called CCA algorithms (CCA=Congestion Control Algorithm) are required for controlling the data speed via the DCCP protocol. These algorithms are implemented in the data network and can be executed for adjusting the data transmission. At present, two CCA algorithms which operate correctly in relation to the TCP protocol are known. The DCCP protocol provides a mechanism by which the suitable CCA algorithm for data adjustment is agreed in the event of data congestion. In order to support the CCA algorithm which is used in the DCCP protocol, the header of the DCCP data contains a data field called CCval. The interpretation of this data field is determined by the relevant CCA algorithm which has been agreed.

In the currently described embodiment of the invention, a third algorithm GCCA (GCCA=Gateway Congestion Control Algorithm) can be initiated in addition to the two CCA algorithms, the third algorithm being executed by the gateway server 3 and used to adjust the data speed in the case of data bottlenecks at the air interface. In order for this GCCA algorithm to function, the algorithm must be given information about the importance of the data packets to be transferred, so that the algorithm can decide which data it can most readily discard in the event of bottlenecks, without resulting in significant impairment of the application for which the data is intended. Therefore it is necessary for the DCCP data packets to contain information about the priority of the individual transmitted data packets.

In the currently described embodiment, the CCval field in the DCCP header is utilized for transferring information relating to the priority of data packets. During the connection setup, the gateway server detects whether the GCCA algorithm is used. If this is the case, the gateway server knows that information relating to the importance of the data packets is contained in the CCval field. Depending on the value of the CCval field, and possibly also on the status or feedback of the data network, the gateway server can then make decisions with the aid of the GCCA algorithm, thereby deciding what should happen to the individual data packets. According to the invention, a preferred decision could be the binary decision whether the data packet is to be discarded or forwarded to the terminal.

The CCval field consists of four bits, i.e. the field can accept 16 different values in total. In addition to signaling the two CCA algorithms which are already provided, further interpretation possibilities of this field can therefore be implemented, from which further actions of the gateway computer can be derived. One possibility for the contents of the CCval field provides for using the size of the value in the CCval field to specify the importance of an encoded data packet for a subsequent correct decoding at the terminal. In this context, for example, the value zero in the field could signify: “Packet can be discarded without affecting the decoding of subsequent packets”. In contrast, the value 15 in the field could signify: “Do not discard, since it will no longer be possible to decode the next subsequent packets otherwise”. Using a signaling of this type, the gateway to the UMTS network in FIG. 2 can be controlled by the gateway server 3 in such a way that packets can be processed corresponding to an application-specific context. The transmission of video data as described below is a typical application area.

A sequence of encoded digitized images is transmitted in a video data stream, wherein the individual data packets contain video frames by which encoded intraframes I, prediction frames P and bidirectional frames B are transmitted. The meaning of the individual frames is sufficiently well known to a person skilled in the art. An intraframe is encoded without using information from other frames. By contrast, a P frame requires information from preceding frames for correct decoding. A B frame is characterized in that inter alia its image information is not used by any of the other frames for encoding.

In a configuration of the GCCA algorithm, the individual frames could be assigned CCval values between 0 and 15 as follows:
I(15)P(14)P(14)B(0)P(13)P(13)B(0) . . . I(15).

In this context, the letter I, P or B signifies a data packet including an I frame, P frame or B frame respectively, and the number in parentheses corresponds to the CCval value which is used for the data packet.

From this sequence, a gateway computer could determine that if a packet is deleted all subsequent packets having a lower CCval value can be discarded, since correct decoding is no longer possible with such packets. For example, if the third packet of the above series is lost, all subsequent packets having a CCval value of less than or equal to 14 can be discarded.

This means that correct decoding only becomes possible again when a new intraframe having the CCval value 15 is transmitted.

More subtle dependencies between the individual frames are also possible in the video encoding. For example, individual prediction frames can be dependent not on the preceding frame but on the frame before the preceding frame. In order to allow for such a dependency, the above described signaling of video frames could be refined further by forming dependency classes containing CCval values. The classes could appear as follows, for example:
{0, 1, 14, 15}, {2, 3, 4, 5}, {6, 7, 8, 9}, {10, 11, 12, 13}

The CCval values of the first class express e.g. global substantive matter, such as the fact that all specified dependencies are reset. The second, third and fourth classes according to the above classification express dependencies between data packets, wherein data packets having CCval values of the same class are dependent on each other. For example, the signaling I(15)P(5)P(9)P(4)P(8)P(3)P(7) would signify:

If the second packet having the CCval value 5 is lost, all packets having CCval values 5, 4, 3, 2 are discarded by the gateway until a reset is sent using the CCval value 15. On the other hand, packets having the CCval values 9, 8, 7, 6 are nonetheless still allowed though by the gateway server since they belong to a different class. By contrast, if the fourth packet having the CCval value 4 is lost, only packets having the CCval values 4, 3, 2 need be discarded, while the packets having CCval values from the other classes or having higher CCval values within the same class need not be discarded.

The above described method essentially provides for information relating to the importance of the data packets to be transferred during the data transmission, wherein such information can be extracted from the layers that are situated above the DCCP transport layer.

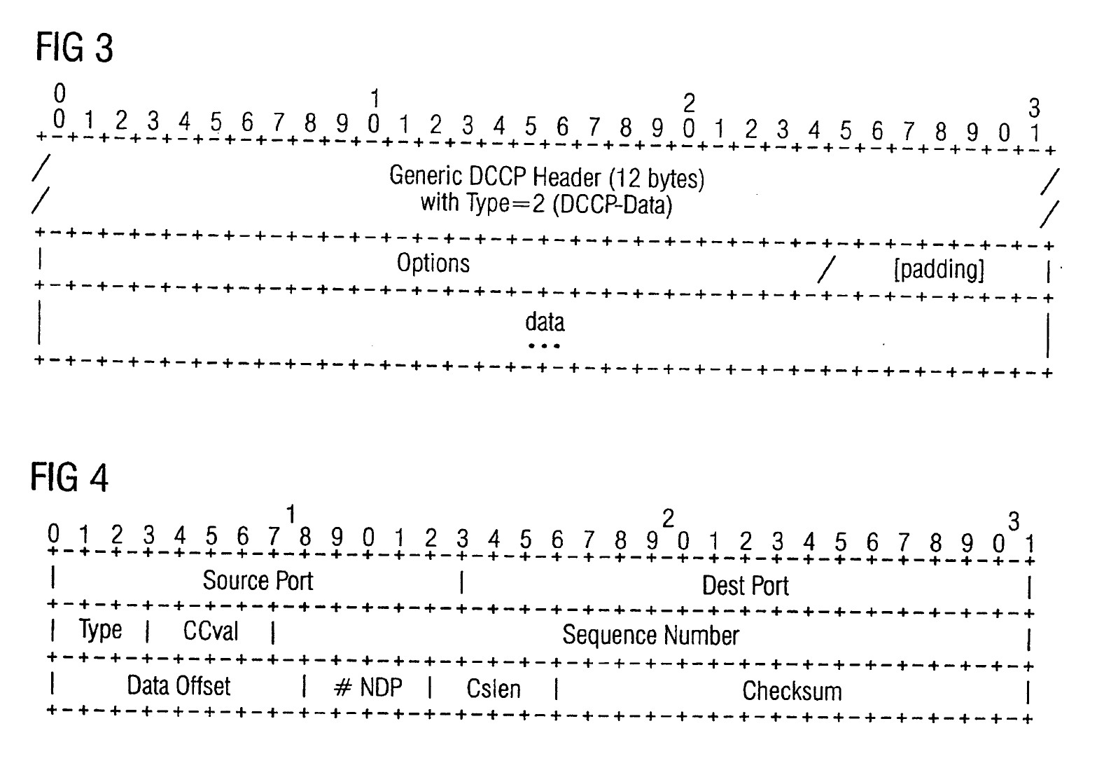

FIG. 3 shows the structure of a DCCP header. The header includes a generic part “Generic DCCP Header”, an options field “Options” and a data field. As an alternative to the previously described CCval field, it is possible to use e.g. the Options field for signaling information relating to the importance of data packets.

FIG. 4 shows the structure of the generic part of the header from FIG. 3. The header contains inter alia the source port and the destination port as information. The previously described CCval field, which can be used to signal the importance of data packets, is contained in the generic part.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A method for transmitting data in a data network, comprising:
transmitting the data using at least one protocol having a plurality of layers, including a transport layer, a plurality of upper layers above the transport layer and a plurality of lower layers below the transport layer, where the transport layer contains information from the upper layers.

16. The method as claimed in claim 15, wherein the information from the upper layers originates from at least one of an application layer and a session layer.

17. The method as claimed in claim 16, wherein the information from the upper layers includes application information relating to an application for which the data being transmitted is provided.

18. The method as claimed in claim 17, wherein the information from the upper layers contains a priority level for the data being transmitted.

19. The method as claimed in claim 18, wherein the data being transmitted includes encoded data and the priority level specifies how important the data is for correct decoding of the encoded data.

20. The method as claimed in claim 19, wherein the data includes encoded digitized images, and the priority level specifies reciprocal dependencies of the encoded digitized images.

21. The method as claimed in claim 20, wherein a real time protocol is utilized in the upper layers.

22. The method as claimed in claim 21, wherein a datagram congestion control protocol is utilized in the transport layer.

23. The method as claimed in claim 22, wherein the information from the upper layers is contained in a CCval field of a generic header of the data transmitted in the datagram congestion control protocol.

24. The method as claimed in claim 22, wherein the information from the upper layers is contained in an options field of a special header of the data transmitted in the datagram congestion control protocol.

25. A device for processing data transmitted in a data network, comprising a processor unit reading and processing information from upper layers, derived from data transmitted in a transport layer below the upper layers, where lower layers exist below the transport layer.

26. The device as claimed in claim 25, wherein said device is a network computer.

27. The device as claimed in claim 26, wherein said network computer is at least one of a gateway server and a proxy server.

28. A data network, comprising:
a device processing data transmitted in the data network, including a processor unit reading and processing information from upper layers, derived from data transmitted in a transport layer below the upper layers, where lower layers exist below the transport layer.

29. The data network as claimed in claim 28, further comprising at least one of a universal mobile telecommunication service network and an internet protocol network.

30. The data network as claimed in claim 25, wherein said device is a network computer.

31. The data network as claimed in claim 26, wherein said network computer is at least one of a gateway server and a proxy server.
